(19) United States
(12) Patent Application Publication
(10) Pub. No.: US 2012/0132486 A1
(43) Pub. Date: May 31, 2012

(54) EMERGENCY ESCAPE DEVICE FOR ELEVATOR

(76) Inventor: YUNG-HSIN CHEN, TAINAN CITY (TW)

(21) Appl. No.: 13/302,137

(22) Filed: Nov. 22, 2011

(30) Foreign Application Priority Data
Nov. 30, 2010 (JP) 2010-267286

(51) Int. Cl. B66B 11/06

(52) U.S. Cl. 187/262; 187/261

(57) ABSTRACT

An emergency escape device for elevators is revealed. The emergency escape device is disposed in an elevator system. The emergency escape device includes a motor having an output end linked to a reduction gear set. An inner gear of the reduction gear set is engaged with a gear of a rope winder around which a steel cable is wound. Thereby the motor is released automatically from braking when the elevator system loses power and stops due to power outage or mechanical failure. Thus an elevator cabin is pulled downward by gravity and the rope winder rotates to unwind the wound steel cable. The steel cable goes down slowly so that the elevator cabin can goes down and stop at the nearest floor, allowing people trapped to come out.

### BACKGROUND OF THE INVENTION

1. Field of the Invention

The present invention relates to an emergency escape device for elevators, especially to an emergency escape device that makes an elevator cabin go down and stop at the nearest floor when an elevator system loses power and stops due to power outage or mechanical failure. Thus people trapped in the elevator cabin can be evacuated.

2. Description of Related Art

Nowadays the downtown area of cities is crowded with people so that the buildings are higher than before. The higher the building, the more floors it contains. For moving people upward and downward to each floor easily and conveniently, most of buildings are equipped with elevator systems. Refer to FIG. 7, an elevator system generally includes a steel cable wheel 611 arranged under an elevator cabin 61. A steel cable 62 is passed through the steel cable wheel 611. One end of the steel cable 62 is fixed in a machine room to form a fixed end 63 while the other end thereof is passed through a main motor 64 in the machine room and then is turned downward to be fixed on a balance weight block 65. Thus the elevator cabin 61 is moved upward and downward by the steel cable 62 that is driven by the main motor 64.

Although the elevator system is convenient transport equipment that moves people between floors efficiently, extrication of trapped occupants can often be difficult when the elevator cabin has an emergency stop due to loss of electrical power or an emergency condition. The elevator cabin may not be perfectly level with the floor, stopped between floors. For people attempt to rescue the occupants in the elevator, the condition is complicated and the rescue is getting difficult. Sometimes due to the limit of the space, it's impossible to force the two doors apart smoothly. Now the occupants can only wait until the power is returned or the failure is repaired and the elevator cabin is moving to a landing position of each floor. Then hoistway doors and doors of the elevator cabin are opened so as to evacuate the occupants. During the waiting period, the occupants may not only feel time pass slowly but also feel afraid. Thus there is room for improvement and there is a need to provide an auxiliary escape device for elevators of higher practical value.

### SUMMARY OF THE INVENTION

Therefore it is a primary object of the present invention to provide an emergency escape device for elevators used for evacuation of occupants when an elevator system stops due to power outage or breakdown.

In order to achieve the above object, an emergency escape device disposed in an elevator system according to the present invention is provided. The emergency escape device includes a motor whose output end is linked to a reduction gear set. An inner gear of the reduction gear set is engaged with a gear of a rope winder. A steel cable is wound around the rope winder. Thereby the motor is released automatically from braking condition when the elevator system loses power and stops due to power outage or breakdown. Thus an elevator cabin is pulled downward by gravity and the rope winder rotates to unwind the wound steel cable. The steel cable is released slowly and going down so that the elevator cabin goes down until it reaches a landing position and stops at the nearest floor, the elevator cabin is opened and people trapped can come out.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective view of an embodiment according to the present invention;

FIG. 2 is a top view of an embodiment according to the present invention;

FIG. 3 is a schematic drawing showing an assembled view of an embodiment according to the present invention;

FIG. 4 is another schematic drawing showing an assembled view of an embodiment according to the present invention;

FIG. 5 is a schematic drawing showing an embodiment in use according to the present invention;

FIG. 6 is another schematic drawing showing an embodiment in use according to the present invention;

FIG. 7 is a perspective view of a prior art.

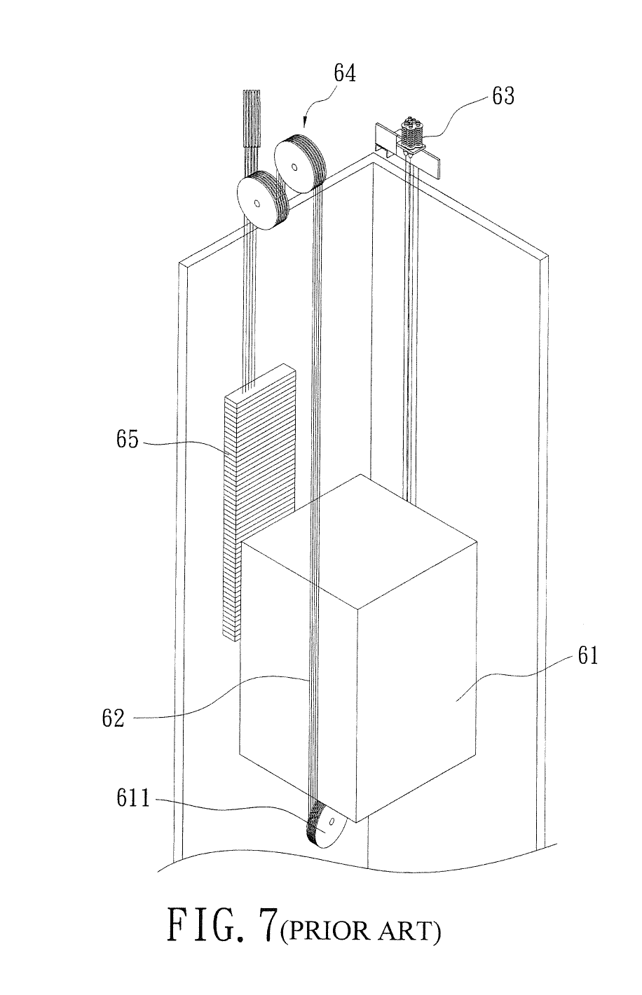

### DETAILED DESCRIPTION OF THE PREFERRED EMBODIMENT

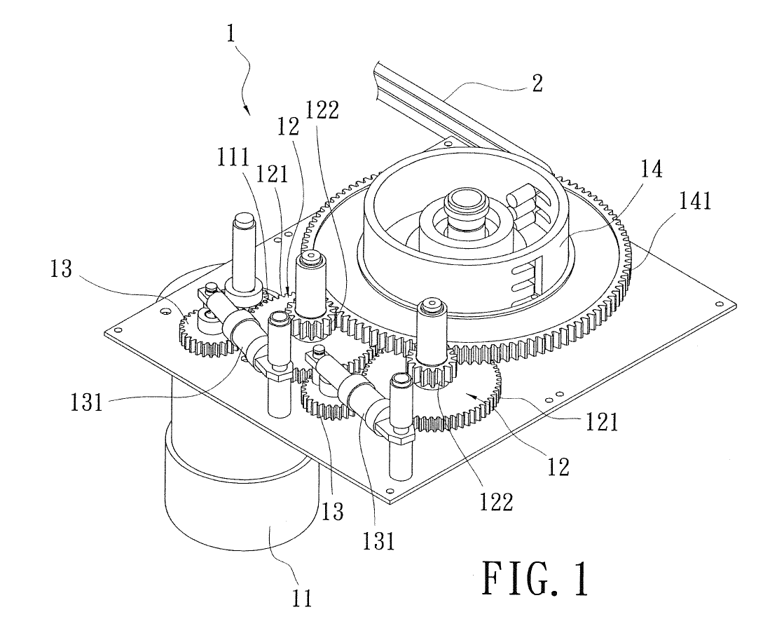

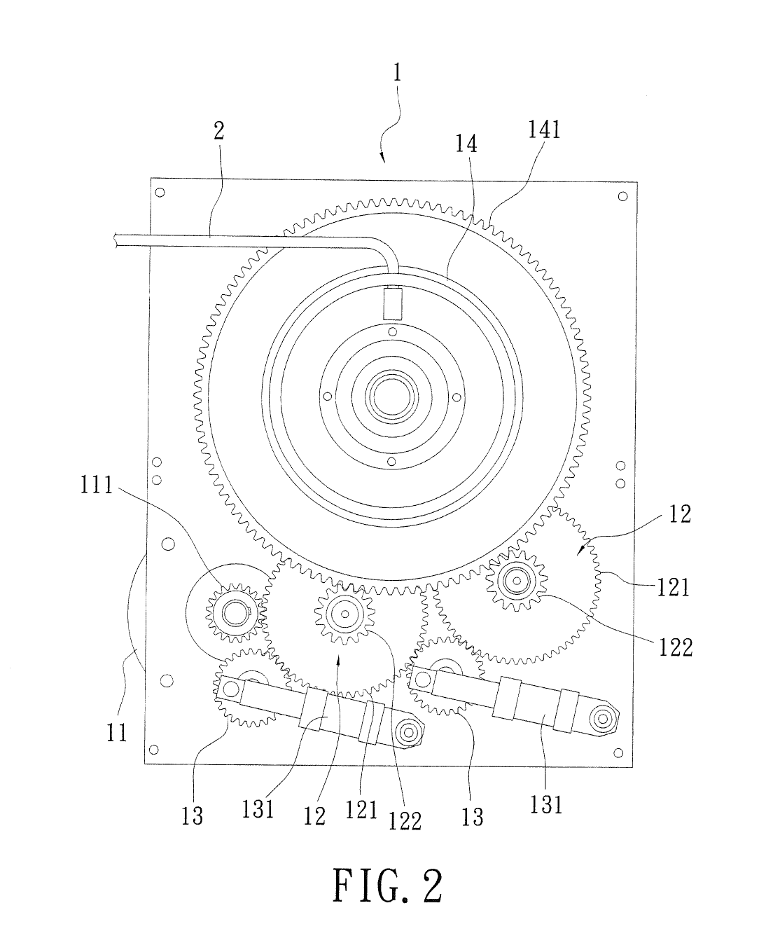

Refer to FIG. 1 and FIG. 2, an emergency escape device 1 arranged in an elevator system includes a motor 11, a reduction gear set 12 linked to and moved with an output end 111 of the motor 11, a slow gear 13 engaged with an outer gear 121 of the reduction gear set 12, and a rope winder 14. The slow gear 13 is pivoted with a slow oil cylinder 131. The emergency escape device 1 can also includes a plurality sets of the slow gears 13. Each set of the slow gear 13 is pivoted with a corresponding slow oil cylinder 131 and is arranged with a reduction gear set 12 correspondingly. Each set of the slow gear 13 is engaged with an outer gear 121 of the corresponding reduction gear set 12 while an inner gear 122 of each reduction gear set 12 is engaged with a gear 141 of the rope winder 14. A steel cable 2 is wound around the rope winder 14 and the length of the steel cable 2 is about the height of one floor.

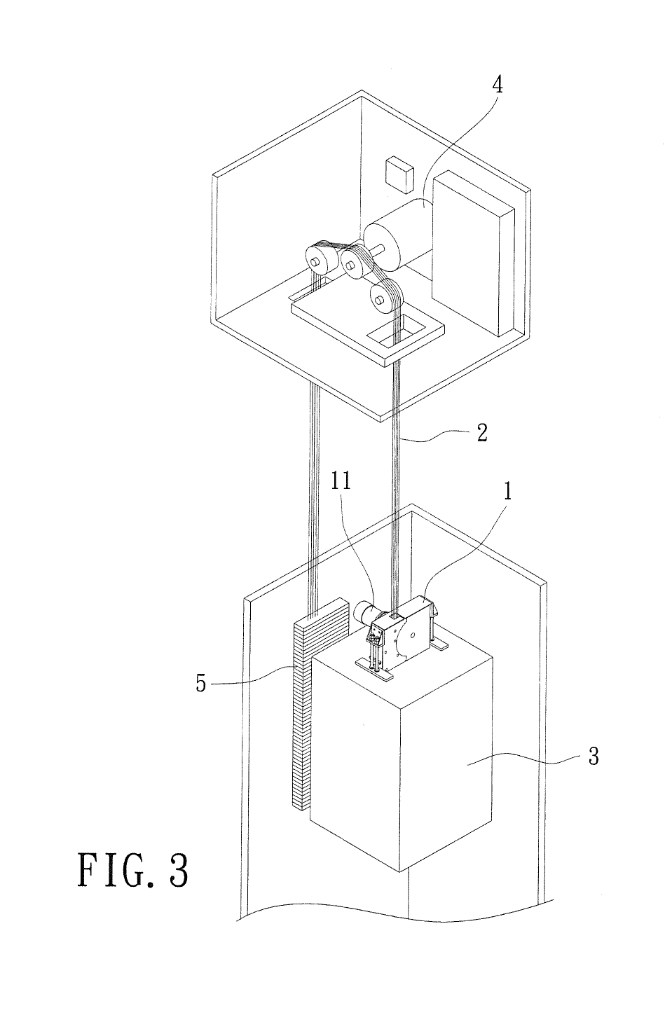

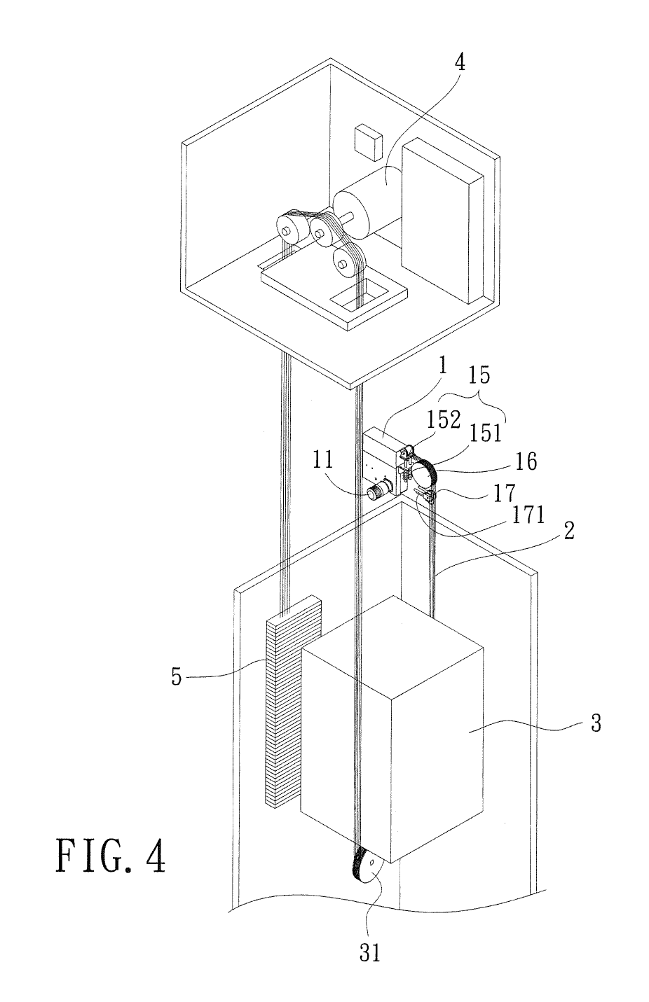

While being assembled, refer to FIG. 3, the emergency escape device 1 is fixed on top of an elevator cabin 3 of an elevator system and the steel cable 2 wound around the rope winder 14 is passed through a main motor 4 that drives the elevator system and then is turned downward to connect to a balance weight block 5. Or refer to FIG. 4, in another assembly way, the emergency escape device 1 is fixed on top of an elevator system. A buffer 15 is disposed correspondingly to the rope winder 14. The buffer 15 includes an elastic part 151 so as to support and fix a top support plate 152 at a preset position by the elastic part 151. A diverting pulley 16 is arranged around the buffer 15. A top support pulley 17 is disposed under the diverting pulley 16 and is connected to a threaded rod 171 so that the position of the top support pulley 17 can be adjusted by the threaded rod 171. The steel cable 2 wound around the rope winder 14 is passed through the buffer 15, the diverting pulley 16, the top support pulley 17, turned downward over a steel cable wheel 31 on a bottom surface of an elevator cabinet 3 and then turned upward over a main motor 4 on top of the elevator system.

During normal operation of the elevator, the steel cable 2 is wound and released by the motor 4 and is used in combination with the balance weight block 5. Now the motor 11 of the emergency escape device 1 is not running and there is a braking force applied to the rope winder 14. Thus the rope winder 14 will not be pulled by the gravity of the elevator cabin 3 to rotate. The emergency escape device 1 has become a fixed end of the steel cable 2 for moving the elevator cabin 3 up or down. Thus the elevator cabin 3 can stop at a landing position near elevator doors of each floor precisely.

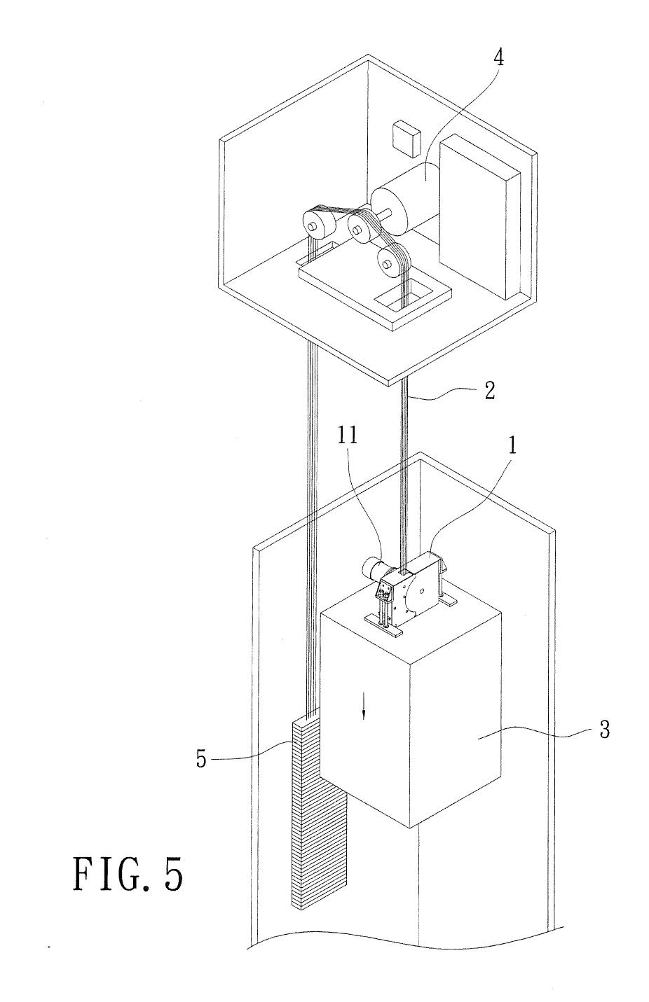

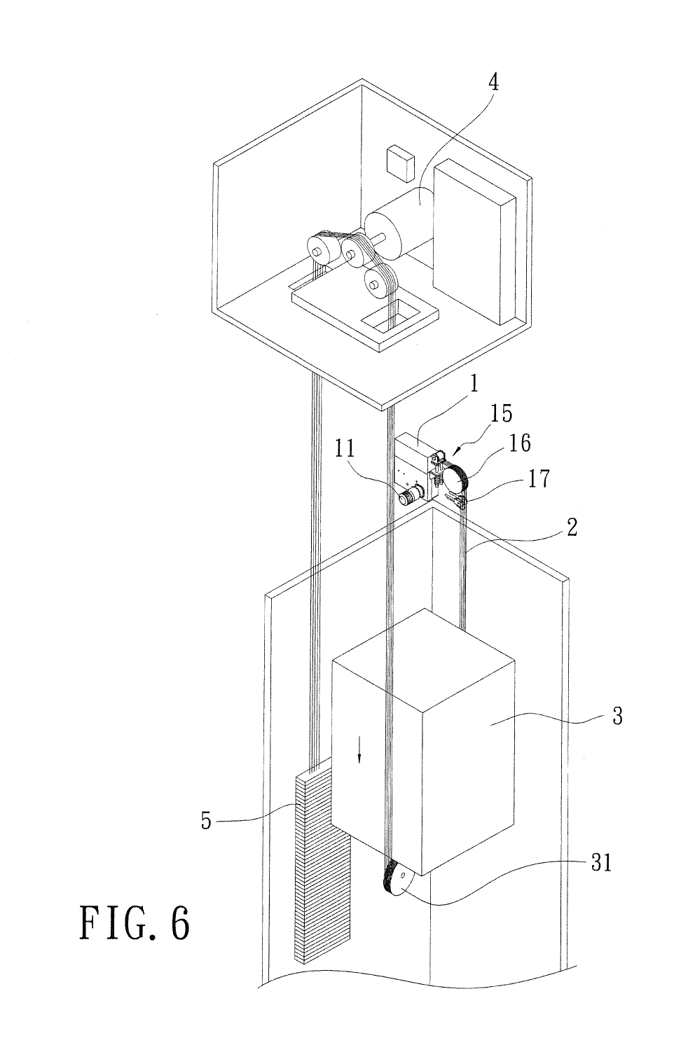

When the power is out or the elevator is out of order, refer to FIG. 5 and FIG. 6, schematic drawings show an embodiment of the present invention in use. The main motor 4 stops running to prevent the elevator cabin 3 from falling. Yet the elevator cabin 3 may stop at the position between two floors. At this moment, the motor 11 of the emergency escape device 1 is released from braking condition automatically. The elevator cabin 3 is pulled downward by gravity and the rope winder 14 rotates to unwind the wound steel cable 2. Due to the gear 141 of the rope winder 14 engaged with the inner gear 122 of each reduction gear set 12, the outer gear 121 of the reduction gear set 12 engaged with the slow gear 13, and the slow oil cylinder 131 pivoted to the slow gear 13, the rope winder 14 rotates slowly and the steel cable 2 wound around the rope winder 14 is released slowly and going down so that the elevator cabin 3 goes down until it reaches the nearest floor, touches a sensor of the elevator system and stops. Then the elevator cabin is opened and people trapped can come out.

After the power returns or the mechanical failure has been repaired, the motor 11 of the emergency escape device 1 runs in the opposite direction and drives the rope winder 14 to wind the steel cable 2 therearound for being used again next time.

In summary, compared with the device available now, the motor of the present invention works to drive the rope winder immediately when the elevator system stops running due to loss of electrical power or mechanical failure. Thus the rope winder rotates slowly so as to move the steel cable wound thereof down gradually and allow the elevator cabin moving downward and landing at the nearest floor. Therefore occupants in the elevator cabin can be easily evacuated.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. An emergency escape device for elevators arranged at an elevator system comprising:
a motor having an output end linked to at least one reduction gear set;
at least one inner gear of the reduction gear set that is engaged with at least one gear of a rope winder; and
a steel cable that is wound around the rope winder.

2. The device as claimed in claim 1, wherein the emergency escape device further includes at least one slow gear engaged with at least one outer gear of the reduction gear set and the slow gear is pivoted with at least one slow oil cylinder.

3. The device as claimed in claim 2, wherein the emergency escape device includes a plurality sets of the slow gears; each set of the slow gear is pivoted with one slow oil cylinder correspondingly and is arranged with one reduction gear set correspondingly; each set of the slow gear is engaged with the outer gear of the corresponding reduction gear set while the inner gear of each reduction gear set is engaged with the gear of the rope winder for supporting gravity load of the elevator cabin.

4. The device as claimed in claim 1, wherein the emergency escape device is fixed on top of an elevator cabin of the elevator system and the steel cable wound around the rope winder of the emergency escape device is passed through a main motor that drives the elevator system and then is turned downward to connect to at least one balance weight block.

5. The device as claimed in claim 1, wherein the emergency escape device is fixed on top of the elevator system and the steel cable wound around the rope winder of the emergency escape device is going downward and passed through a steel cable wheel on a bottom surface of an elevator cabinet, then turned upward over a main motor arranged at top of the elevator system for driving the elevator system, and finally turned downward to connect to at least one balance weight block.

6. The device as claimed in claim 4, wherein the emergency escape device further includes at least one buffer arranged correspondingly to the rope winder; the buffer having at least one elastic part so that a top support plate is supported and fixed at a preset position by the elastic part; at least one diverting pulley is arranged around the buffer; at least one top support pulley is disposed under the diverting pulley and is connected to a threaded rod so that a position of the top support pulley is adjusted by the threaded rod; the steel cable is passed through the buffer, the diverting pulley, and the top support pulley.
